(19) United States
(12) Patent Application Publication
(10) Pub. No.: US 2026/0230786 A1
(43) Pub. Date: Aug. 6, 2026

(54) DYNAMIC PROFILE PRIORITIZATION FOR MULTIPLE SUBSCRIBER IDENTIFICATION MODULE (SIM) PROFILES

(71) Applicant: Charter Communications Operating, LLC, St. Louis, MO (US)

(72) Inventors: Vinayak K. Thotton Veettil, Parker, CO (US); William Kenneth Logan, Overland Park, KS (US); Erik Atom Anderson, Aurora, CO (US); Yohanes Gunawan, Littleton, CO (US)

(21) Appl. No.: 19/047,294

(22) Filed: Feb. 6, 2025

(51) Int. Cl. H04W 4/50; H04W 4/029; H04W 8/18

(52) U.S. Cl. CPC H04W 4/50; H04W 4/029; H04W 8/18

(57) ABSTRACT

Occurrence of a profile prioritization event for a set of Subscriber Identification Module (SIM) profiles of a mobile device is detected. The SIM profiles include a primary SIM profile that grants access to primary services of a plurality of service types and a first associated SIM profile that grants access to an associated service of a first service type. A set of contextual inputs are processed with a machine-learned dynamic profile prioritization model to obtain a first priority value for the associated service of the first service type. A determination is made that the first priority value for the associated service is greater than a second priority value for a primary service of the same service type. Based on the determination, the associated service of the first service type is activated at the mobile device by a wireless protocol stack instance of the mobile device.

### BACKGROUND

In the context of telecommunications, a Subscriber Identity Module (SIM) profile refers to a collection of data and credentials-such as an International Mobile Subscriber Identity (IMSI), authentication keys, network parameters, subscription information, etc. Conventional SIM profiles can be either physical or digital. “Physical” sim profiles are generally stored on removable “cards” that can be swapped in and out of mobile devices. For example, a user may be provided a physical SIM profile (and corresponding card) when they subscribe to a network service provider. Alternatively, “digital” SIM profiles are generally stored to the memory of a mobile device or to a specific SIM storage device of the mobile device, such as an embedded Universal Integrated Circuit Card (eUICC)).

SIM profiles can grant access to certain services, such as high-speed wireless data, phone services, video streaming, mixed reality streaming, geolocation services, etc. Traditionally, SIM profiles have been provided by network service providers so that subscribers can access the network services they subscribe to. However, in recent years, SIM profiles have been utilized by other entities to grant access to similar types of services offered by network service providers. For example, a professional sports organization may provide a SIM profile to stadium attendees that grants access to local wireless services specific to the stadium.

### SUMMARY

Implementations described herein provide for dynamic profile prioritization for multiple SIM profiles. More specifically, a computing device (e.g., a system for a network service provider, a mobile computing device, etc.) can detect occurrence of a profile prioritization event. The computing device can include a primary SIM profile and associated SIM profile(s) that grant access to primary and associated services, respectively. The computing device can process contextual inputs with a machine-learned model to generate a priority value for one of the associated SIM profiles (or a service granted access by the associated SIM profile). The computing device can make a determination that the priority value is greater than another priority value of the same type of service. The computing device can then cause the associated service to be activated at the mobile device by a first wireless protocol stack instance of one or more wireless protocol stack instances of the mobile device.

In one implementation, a method is provided. The method includes detecting, by a computing device comprising one or more processor devices, occurrence of a profile prioritization event for a set of Subscriber Identification Module (SIM) profiles of a mobile device, including a primary SIM profile that grants access to a plurality of primary services of a respective plurality of service types and a first associated SIM profile that grants access to an associated service of a first service type of the plurality of service types. The method further includes, responsive to detecting the occurrence of the profile prioritization event, processing, by the computing device, a set of contextual inputs with a machine-learned dynamic profile prioritization model to obtain a first priority value for the associated service of the first service type. The method further includes making, by the computing device, a determination that the first priority value for the associated service of the first service type is greater than a second priority value for a primary service of the first service type from the plurality of primary services. The method further includes, based on the determination, causing, by the computing device, the associated service of the first service type to be activated at the mobile device by a first wireless protocol stack instance of one or more wireless protocol stack instances of the mobile device.

In another implementation, a computing device is provided. The computing device includes a memory, and a processor device coupled to the memory. The processor device is to detect occurrence of a profile prioritization event for a set of SIM profiles of the mobile device including a primary SIM profile that grants access to a plurality of primary services of a respective plurality of service types and a first associated SIM profile that grants access to an associated service of a first service type of the plurality of service types. The processor device is further to, responsive to detecting the occurrence of the profile prioritization event, process a set of contextual inputs with a machine-learned dynamic profile prioritization model to obtain a first priority value for the associated service of the first service type. The processor device is further to make a determination that the first priority value for the associated service of the first service type is greater than a second priority value for a primary service of the first service type from the plurality of primary services. The processor device is further to, based on the determination, activate the associated service of the first service type at the mobile device with a first wireless protocol stack instance of one or more wireless protocol stack instances of the mobile device.

In another implementation, a non-transitory computer-readable storage medium is provided. The non-transitory computer-readable storage medium includes executable instructions to cause one or more processor devices to detect occurrence of a profile prioritization event for a set of SIM profiles of the mobile device including a primary SIM profile that grants access to a plurality of primary services of a respective plurality of service types and a first associated SIM profile that grants access to an associated service of a first service type of the plurality of service types. The instructions further cause the processor device(s) to, responsive to detecting the occurrence of the profile prioritization event, process a set of contextual inputs with a machine-learned dynamic profile prioritization model to obtain a first priority value for the associated service of the first service type. The instructions further cause the processor device(s) to make a determination that the first priority value for the associated service of the first service type is greater than a second priority value for a primary service of the first service type from the plurality of primary services. The instructions further cause the processor device(s) to, based on the determination, cause the associated service of the first service type to be activated at the mobile device by a first wireless protocol stack instance of one or more wireless protocol stack instances of the mobile device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing environment suitable for implementing dynamic profile prioritization for multiple SIM profiles according to some implementations of the present disclosure.

FIG. 2 depicts a flow chart diagram of an example method to perform dynamic prioritization of SIM profiles according to some implementations of the present disclosure.

FIG. 3 depicts a flow chart diagram of an example method for local mobile-based prioritization of SIM profiles according to some implementations of the present disclosure.

FIG. 4 depicts a flow chart diagram of an example method for downloading associated SIM profiles for local mobile-based prioritization of SIM profiles according to some implementations of the present disclosure.

FIG. 5 depicts a flow chart diagram of an example method for enabling an active set of SIM profiles for local mobile-based prioritization of SIM profiles according to some implementations of the present disclosure.

FIG. 6 depicts a flow chart diagram of an example method for deleting and/or removing a primary SIM profile for local mobile-based prioritization of SIM profiles according to some implementations of the present disclosure.

FIG. 7 depicts a flow chart diagram of an example method for disabling a primary SIM profile for local mobile-based prioritization of SIM profiles according to some implementations of the present disclosure.

FIG. 8 depicts a flow chart diagram of an example method for adding a non-associated SIM profile for local mobile-based prioritization of SIM profiles according to some implementations of the present disclosure.

FIG. 9 depicts a flow chart diagram of an example method for disabling/removing a non-associated SIM profile for local mobile-based prioritization of SIM profiles according to some implementations of the present disclosure.

FIG. 10 is a block diagram of the computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

In the context of telecommunications, a Subscriber Identity Module (SIM) profile refers to a collection of data and credentials-such as an International Mobile Subscriber Identity (IMSI), authentication keys, network parameters, subscription information, etc. Conventional SIM profiles can be either physical or digital. “Physical” sim profiles are generally stored on removable “cards” that can be swapped in and out of mobile devices. For example, a user may be provided a physical SIM profile (and corresponding card) when they subscribe to a network service provider. Alternatively, “digital” SIM profiles are generally stored to the memory of a mobile device or to a specific SIM storage device of the mobile device, such as an embedded Universal Integrated Circuit Card (eUICC)).

SIM profiles can grant access to certain services, such as high-speed wireless data, phone services, video streaming, mixed reality streaming, geolocation services, etc. Traditionally, SIM profiles have been provided by network service providers so that subscribers can access the network services they subscribe to. However, in recent years, SIM profiles have been utilized by other entities to grant access to similar types of services offered by network service providers. For example, a professional sports organization may provide a SIM profile to stadium attendees that grants access to local wireless services specific to the stadium.

As such, it is relatively common for a mobile device or User Equipment (UE) to include multiple SIM profiles. In most scenarios, a mobile device will include a primary SIM profile and one or more associated SIM profiles. A primary SIM profile is usually provided by a user's primary network service provider, and grants access to a variety of service types typically offered by network service providers (e.g., high-speed internet, phone service, texting, video streaming, geolocation, etc.). Associated SIM profiles are usually provided by an entity other than the primary network service provider, and grant access to one or more services of the same type(s) as those of the primary SIM profile. For example, a primary SIM profile may grant access to high-speed internet via a particular network service provider, while an associated SIM profile may grant access to high-speed internet via a different network service provider.

When a UE (i.e., mobile device) includes multiple SIM profiles that provide access to multiple services of the same type (e.g., two profiles granting access to two different high-speed internet services), the service that is most “optimal” can sometimes change multiple times per day. To follow the previous example, in certain locations, the high-speed internet service granted by the primary SIM profile may exhibit weak performance while the high-speed internet service granted by the associated SIM profile exhibits strong performance, and vice versa in other geographic areas. As such, the capability to dynamically prioritize SIM profiles based on the service(s) granted by the profiles could substantially increase performance for mobile devices.

Accordingly, implementations described herein provide for dynamic profile prioritization for multiple SIM profiles. More specifically, a computing device (e.g., a system for a network service provider, a mobile computing device, etc.) can detect occurrence of a profile prioritization event. As described herein, a profile prioritization event refers to some event that triggers prioritization (or re-prioritization) of some or all SIM profiles for a UE. Examples of profile prioritization events can include a UE changing location, network performance metrics for the UE degrading, a certain amount of time passing since prioritization last occurred, a new SIM profile being received, or a wireless protocol stack instance becoming available (e.g., a fifth-generation (5G) new radio (NR) stack instance, a fourth generation (4G) long-term evolution (LTE) stack instance, etc.).

The computing device can detect the profile prioritization event for a set of SIM profiles of a mobile device. As described herein, a SIM profile can refer to either a primary SIM profile or an associated SIM profile. A primary SIM profile grants access to a variety of different services (e.g., voice communication, high-speed internet access, video streaming, geolocation, etc.). Primary SIM profiles are typically provided by network service providers to subscribers who subscribe to network services. Associated SIM profiles grant access to one or more of the types of services granted by the primary SIM profile (or primary SIM profiles generally). For example, if a primary SIM profile grants access to voice communication, high-speed internet, and geolocation services, one associated SIM profile may grant access to another high-speed internet service (i.e., an internet service provided by a different service provider), while a second associated SIM profile grants access to a different geolocation service.

It should be noted that services may be referred to herein as “primary” services and “associated” services. A primary service refers to a service that is granted by a primary SIM profile, while an associated service refers to a service granted by an associated SIM profile. In some instances, the type of SIM profile (e.g., primary or associated) that grants access to a service may be the only difference between a primary service and an associated service. For example, a high-speed internet service may be considered an associated service for a user that accesses the service via an associated SIM profile, while the same service may be considered a primary service for a different user that accesses the service via a primary SIM profile. Conversely, some associated services are more likely to be granted by an associated SIM profile than a primary SIM profile, such as a local high-speed WiFi service within a stadium.

Associated SIM profiles can be granted for a variety of different use-cases. For example, an associated SIM profile may be granted by the provider of a primary SIM profile to provide access to foreign wireless networks while a subscriber is traveling abroad. For another example, an associated SIM profile may be granted by a professional sports organization to a user in a stadium to grant the user temporary access to the stadium's wireless networks. For yet another example, a user who subscribes to multiple high-speed internet services may receive multiple associated SIM profiles granting access to those services.

In response to detecting the occurrence of the profile prioritization event, the computing device can process a set of contextual inputs with a machine-learned dynamic profile prioritization model. The set of contextual inputs can be obtained for an associated service granted by a particular associated SIM profile. The set of contextual inputs can include information or data elements related to the associated service, the mobile device, the network infrastructure used to facilitate the associated service, historical user information, etc. Examples of contextual inputs include a current time, a location of the mobile device, user preferences or settings, current or predicted network performance metrics, performance metrics for other services of the same service type, etc.

The model can process the set of contextual inputs to generate a priority value for the associated service granted by the associated SIM profile. In some instances, the priority value can indicate a priority of the associated service relative to other accessible services of the same service type (e.g., services granted by other SIM profiles). For example, if the SIM profiles accessible to the mobile device grant access to two different geolocation services, the geolocation services can be prioritized relative to each other. Additionally, or alternatively, in some instances, the associated SIM profile itself can be prioritized.

The computing device can make a determination that the priority value generated for the associated service is greater than a priority value for a primary service of the same service type. For example, assume that the associated service is an associated high-speed internet service. Further assume that the primary SIM profile grants access to a primary high-speed internet service that leverages different network infrastructure than that of the associated internet service. In certain locations, the primary internet service may be prioritized over the associated internet service (e.g., locations optimally served by the network infrastructure of the primary internet service). However, if the mobile device is moved to a location that is more optimally served by the network infrastructure of the associated SIM service, the model can process the set of contextual inputs (e.g., including a location of the mobile device) to generate a priority value that prioritizes the associated internet service over the primary internet service.

It should be noted that the set of contextual inputs can generally include a variety of factors for the machine-learned model to evaluate, rather than a decision based on a specific element such as location. To follow the previous example, in addition to the location of the mobile device, the model may further evaluate historical performance metrics for the associated internet service, whether the associated internet service includes data caps or is pay-by-use, whether the user has indicated a preference towards (or away from) the associated internet service, whether the performance difference between the primary internet service and associated internet service is sufficiently great, etc.

Based on the determination, the computing device can cause the associated service to be activated by a wireless protocol stack instance of the mobile device. For example, if a wireless protocol stack instance is available, the mobile device can execute and implement the associated internet service with the available wireless protocol stack instance. Alternatively, if a wireless protocol stack instance is not available, the mobile device can re-assign a wireless protocol stack instance being used to implement some other service to instead implement the associated internet service. In such fashion, implementations described herein can dynamically prioritize SIM profiles in real-time, thus ensuring utilization of optimal network services in a current context.

Implementations of the present disclosure provide a number of technical effects and benefits. As one example technical effect and benefit, implementations described herein can substantially improve network and computing device performance by selecting the most optimal network services in real-time. For example, assume that a mobile device has received a compute workload from an application executing on the mobile device. The compute workload can be offloaded to a cloud system only if the bandwidth of the wireless network used by the mobile device is sufficient. Further assume that a primary wireless service of the mobile device (i.e., a wireless service granted by the primary SIM profile) provides insufficient bandwidth for workload offloading while an associated wireless service provides sufficient bandwidth for workload offloading. If the primary wireless service is active, a conventional approach may determine that the bandwidth of the primary wireless service is insufficient and then begin processing the workload locally, thus utilizing substantial local computing resources (e.g., power, battery, memory, compute, storage, etc.) and degrading performance of the mobile device.

Conversely, implementations described herein can detect a profile prioritization event when the compute workload is received. The computing device can obtain a set of contextual inputs including an input that describes a minimum bandwidth for offloading the workload. Based on the minimum bandwidth being less than the bandwidth provided by the associated wireless service, the machine-learned dynamic profile prioritization model can output a priority value that prioritizes the associated wireless service over the primary wireless service. The computing device can then cause the associated wireless service to be activated with a wireless protocol stack instance and utilize the associated wireless service to offload the workload to the cloud system, thus obviating substantial expenditures of computing resources and associated performance degradation typically caused by conventional approaches.

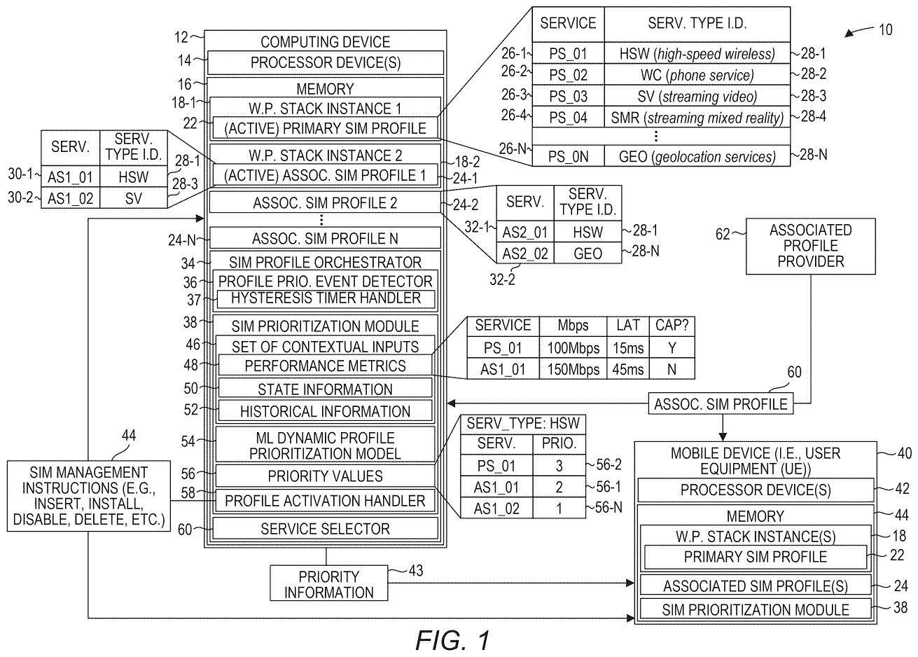

FIG. 1 is a block diagram of a computing environment 10 suitable for implementing dynamic profile prioritization for multiple SIM profiles according to some implementations of the present disclosure. A computing environment 10 can include a computing device 12 with one or more processor device(s) 14 and a memory 16. As described herein, the “computing environment” 10 can be any type or manner of computing environment (e.g., a collection of computing devices, systems, and related infrastructure associated with a particular entity or organization), such as a “confidential” computing environment in which sensitive data and code is protected during processing, a “public” computing environment, etc. For example, the computing environment 10 can be or otherwise include a confidential computing “enclave” that leverages hardware-based execution environments and secure virtualization technologies, such as memory encryption, to isolate critical computations and prevent unauthorized access to data while in use. For another example, the computing environment 10 can be a distributed computing environment that utilizes computing resources across a variety of different types of devices (e.g., servers, virtualized devices, user devices, Internet-of-Things (IoT) devices, etc.).

Additionally, or alternatively, in some implementations, the computing environment 10 can be a cloud computing environment implemented using the computing device 12. For example, the computing device 12 can implement a cloud computing platform by implementing a variety of cloud modules to provide cloud functionality. The cloud computing platform implemented by the computing device 12 can be utilized by various users, entities, organizations, devices, etc. within (and/or external to) the computing environment 10.

In some implementations, the computing device 12 may be a computing device that includes multiple computing devices (i.e., a computing system). Alternatively, in some implementations, the computing device 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the computing environment 10 can include multiple types of nodes. As described herein, a “node” generally refers to a discrete unit of hardware and/or software resources. In some instances, nodes within the computing environment 10 can be configured to perform specific tasks.

For example, some nodes within the computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

In some implementations, the memory 16 of the computing device 12 can include a plurality of wireless protocol stack instances 18-1-18-N (generally, wireless protocol stack instances 18). As described herein, a wireless protocol stack instances can refer to a collection of software resources, services, protocol layers, etc. specific to a particular type of wireless communication standard, such as 4G LTE, 5G NR, etc. The wireless protocol stack instances 18 can be used to activate (and implement) SIM profiles. Additionally, or alternatively, in some implementations, the wireless protocol stack instances 18 can be included in a mobile device 20, and the computing device 12 can manage the wireless protocol stack instances by communicating with the mobile device 20 (e.g., to prioritize various SIM profiles).

The wireless protocol stack instances 18 can activate and implement associated and primary SIM profiles. To follow the depicted example, the wireless protocol stack instance 18-1 can be used to activate primary sim profile 22, and the wireless protocol stack instance 18-2 can be used to activate associated SIM profile 24-1. The memory 16 can also include a plurality of other associated SIM profiles 24-2-24-N (generally, associated SIM profiles 24) that are not currently active (i.e., activated with a wireless protocol stack instance).

The primary SIM profile 22 can grant access to a plurality of primary services 26-1-26-N(generally, primary services 26) of a respective plurality of service types 28-1-28-N(generally, service types 28). More specifically, each of the primary services 26 can have a corresponding service type of the service types 28. The associated SIM profile 24-1 can grant access to one or more first associated service(s) 30-1 and 30-2 (generally, first associated services 30), while the associated SIM profile 24-2 can grant access to one or more second associated service(s) 32-1 and 32-2 (generally, second associated services 30). As depicted, both the primary SIM profile 22 and the associated sim profile 24-1 are actively implemented with wireless stack protocol instances 18. The primary SIM profile 22 can grant access to a primary service 26-1 of a high-speed wireless service type 28-1 while the associated sim profile 24-1 can grant access to an associated service 30-1 of the same high-speed wireless service type 28-1. In other words, the primary SIM profile 22 can grant access to a particular high-speed wireless service while the associated SIM profile 24-1 grants access to a different high-speed wireless service.

As described previously, a “primary” service refers to a particular service granted by the primary SIM profile 22. An “associated” service refers to a particular service granted by one (or more) of the associated SIM profiles 24. Whether a service is considered a primary service or an associated service is merely determined by whether access to the particular service is granted by a primary SIM profile or an associated SIM profile. For example, the primary service 26-1 would be considered an associated service if access to the primary service 26-1 was granted by the associated SIM profile 24-1 rather than the primary SIM profile 22.

The memory 16 of the computing device 12 can include a SIM profile orchestrator 34. The SIM profile orchestrator 34 can handle various operations for handling multiple SIM profiles on mobile devices, such as prioritizing SIM profiles, distributing SIM profiles, updating or modifying SIM profiles, etc. More specifically, the SIM profile orchestrator 34 can include a profile prioritization event detector 36. The profile prioritization event detector 36 can detect occurrence of profile prioritization events. As described herein, a profile prioritization event can refer to any event associated with the computing device 12, a mobile device managed by the computing device 12, network infrastructure, the location of the computing device 12, or the like. To follow the previous example, a profile prioritization event can refer to receiving a compute workload to fulfill. Other examples of profile prioritization events can include the computing device 12 (or a UE managed by the computing device 12) changing location, degrading network performance metrics, a certain amount of time passing since prioritization last occurred, a new SIM profile being received, or a wireless protocol stack instance becoming available, etc.

The profile prioritization event detector 36 can include a variety of hardware and/or software resources sufficient to detect various types of profile prioritization events. Additionally, in some instances, the profile prioritization event detector 36 can communicate with external resources to obtain information related to profile prioritization events. For example, the profile prioritization event detector 36 may request network performance metrics from network monitoring entities to determine whether network performance has degraded. In some implementations, the profile prioritization event detector 36 may include Application Programming Interfaces (APIs) accessible by applications executing on (or off) the computing device 12. For example, if one of the service types 28 is sensitive to inclement weather, the profile prioritization event detector 36 may receive weather-related information from a weather tracking application via one such API. For another example, the profile prioritization event detector 36 may receive performance metrics for the computing device 12 via the APIs (e.g., performance metrics or utilization metrics for the processor device(s) 14, the memory 16, etc.).

In some implementations, the profile prioritization event detector 36 can include a hysteresis timer handler 37. The hysteresis timer handler 37 can create and monitor hysteresis timers for particular SIM profiles of the SIM profiles 22/24. In some implementations, hysteresis timers can track an amount of time since a SIM profile and/or a service granted by a SIM profile was last activated or deactivated. If a hysteresis timer has not yet expired, the hysteresis timer can block activation or deactivation of SIM profiles and/or services granted by SIM profiles. In some implementations, expiration of a hysteresis timer can be detected by the profile prioritization event detector 36 as a profile prioritization event occurring.

For example, assume that the associated service 30-1 is re-prioritized such that the associated service 30-1 is lower priority than the associated service 32-1. Further assume that the hysteresis timer handler 37 is maintaining a currently active (i.e., non-expired) hysteresis timer for the associated service 30-1 (or the associated SIM profile 24-1) that was initiated when the associated SIM profile 24-1 was activated. In this instance, the associated SIM profile 24-1 may remain active until expiration of the hysteresis timer occurs.

In some implementations, the SIM profile orchestrator 34 can include a SIM prioritization module 38. The SIM prioritization module 38 can prioritize the primary SIM profile 22 and the associated SIM profiles 24. More specifically, the SIM prioritization module 38 can prioritize multiple services of the same service type granted by the SIM profiles. For example, the primary service 26-1 of the high-speed wireless service type 28-1 can be prioritized relative to the first associated service 30-1 and the second associated service 30-2 of the same high-speed wireless service type 28-1.

As described above, in some implementations, the SIM prioritization module 38 can prioritize specific services relative to other services of the same service type. Additionally, in some implementations, the SIM prioritization module 38 can prioritize SIM profiles based on the prioritization of the services granted by the SIM profiles. In other words, the SIM prioritization module 38 can prioritize a SIM profile based on the aggregate priority of the service(s) granted by the SIM profile. For example, if the SIM prioritization module 38 assigns a “high” priority for the associated service 30-1 and a “low” priority for the associated service 30-2, the SIM prioritization module 38 may assign a “medium” priority to the associated SIM profile 24-1 itself.

In some implementations, the SIM prioritization module 38 can prioritize services granted by SIM profiles for a UE or mobile device that stores the SIM profiles. For example, the computing environment 10 can include a mobile device 40. The mobile device 40 can include processor device(s) 42 and a memory 44 as described with regards to the processor device(s) 14 and the memory 16 of the computing device 12. The memory 44 of the mobile device 40 can include one or more of the wireless protocol stack instances 18. The memory of the mobile device 40 can further include the primary SIM profile 22 and the associated SIM profiles 24. The SIM prioritization module 38 can receive contextual information related to the SIM profiles 22/24 located on the mobile device 40. Based on the contextual information, the SIM prioritization module 38 can then generate priority information 43 that prioritizes services granted by the SIM profiles 22/24 at the mobile device 40.

Alternatively, in some implementations, the mobile device 40 can include the SIM prioritization module 38 (or an instance thereof), and can locally prioritize the SIM profiles 22/24 using the SIM prioritization module 38. As such, it should be generally understood that the SIM prioritization module 38 can be implemented remotely as a cloud-based service for mobile devices such as the mobile device 40, and/or can be implemented locally on the mobile device 40. In some implementations, some operations attributed to the SIM prioritization module 38 can be performed locally while other operations are performed remotely using multiple instances of the SIM prioritization module 38. For example, the mobile device 40 may locally utilize the SIM prioritization module 38 to prioritize services of the high-speed internet service type 28-1 due to availability of network performance metrics at the mobile device 40. However, the mobile device 40 may also request remote prioritization of streaming mixed reality service type 28-4 via the computing device 12 due to a lack of mixed reality performance metrics at the mobile device 40, a computational load associated with evaluating mixed reality performance metrics, etc.

To prioritize SIM profiles (and/or the services granted by SIM profiles), the SIM prioritization module 38 can obtain a set of contextual inputs 46. The set of contextual inputs 46 can include any type or manner of information related to prioritization of services granted by the SIM profiles (e.g., primary SIM profile 22 and associated SIM profiles 24). In some implementations, the set of contextual inputs 46 can include performance metrics 48. The performance metrics 48 can measure performance of hardware or software resources at the computing device 12, the mobile device 40, or a wireless network leveraged by one of the primary services 26 or the associated services 30/32.

Specifically, in some implementations, the performance metrics 48 can measure performance of services granted by the SIM profiles 22/24. In some implementations, the performance metrics 48 can be service-agnostic. For example, the performance metrics 48 can evaluate a computing resource utilization, battery utilization, etc. associated with specific services. Additionally, or alternatively, in some implementations, the performance metrics can be specific to particular service types. For example, if the associated service evaluated by the SIM prioritization module 38 is of the high-speed internet service type 28-1, the performance metrics 48 can include an average latency, upload bandwidth, download bandwidth, average upload bandwidth in specific geographic regions, etc. For another example, if the associated service is of the geolocation service type 28-N, the performance metrics can include an expected accuracy of the geolocation service, a refresh rate of the geolocation service, an accuracy of the geolocation service within specific geographic regions, etc.

Additionally, or alternatively, in some implementations, the performance metrics 48 can measure performance of the device that includes the wireless protocol stack instances 18 and the SIM profiles 22/24. For example, if the SIM prioritization module 38 is remotely prioritizing a service granted by one of the associated sim profiles 24 activated with the wireless protocol stack instances 18 at the mobile device 40, the performance metrics may measure current and/or predicted CPU utilization, memory utilization, temperatures, accessible network bandwidth, battery life, etc. of the mobile device 40.

Additionally, or alternatively, in some implementations, the performance metrics 48 can include information received from applications executing at the mobile device 40. For example, an application executing at the mobile device 40 may report packet loss, high latency, etc. For another example, an application executing at the mobile device 40 may report inaccurate geolocation readings. For yet another example, an application executing at the mobile device 40 may report a predicted or planned utilization of computing resources by the application at the mobile device 40.

Additionally, or alternatively, in some implementations, the set of contextual inputs 46 can include state information 50. The state information 50 can describe a current state of the computing device 12, the mobile device 40, and/or network resources leveraged by the mobile device 40. For example, the state information 50 can include a current location of the mobile device 40. For another example, the state information 50 can identify network infrastructure leveraged by the mobile device 40 (and/or identify the entity (e.g., a network service provider) that implements said network infrastructure).

In some implementations, the state information 50 can describe requirements for activating services of particular service types of the service types 28. For example, the state information 50 may indicate that a particular service type, such as the streaming video service type 28-3 requires availability of a particular hardware device for video encoding. For another example, the state information 50 can indicate that the phone service 28-2 requires access to a voice input device. In some implementations, the state information 50 can describe requirements for applications executing on the mobile device 40. For example, the state information 50 may indicate that an application executing on the mobile device 40 requires a particular minimum upload rate, a maximum degree of packet loss, etc.

Additionally, or alternatively, in some implementations, the set of contextual inputs 46 can include historical information 52. The historical information 52 can describe previous prioritization decisions (or intermediate representations thereof) in addition to user preferences, prior indications of user preferences, prior performance metrics, prior state information, etc.

The SIM prioritization module 38 can include a machine-learned dynamic profile prioritization model 54. The machine-learned dynamic profile prioritization model 54 can be a model trained to process the set of contextual inputs 46 to generate a first priority value 56-1 of a plurality of priority value 56-1-56-N(generally, priority values 56). The priority value 56 can prioritize one of the first associated services 30 granted by one of the associated SIM profiles 24. For example, assume that three of the associated SIM profiles 24 grant access to three associated services of the high-speed wireless service type 28-1. Priority values can be generated for each of the associated services using the machine-learned dynamic profile prioritization model 54. The priority values can rank a priority of each service relative to each other. In other words, the priority values would rank the three high-speed wireless services as first priority, second priority, or third priority.

The machine-learned dynamic profile prioritization model 54 can be any type or manner of machine-learned model, such as such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

The machine-learned dynamic profile prioritization model 54 can be trained to prioritize SIM profiles using any type or manner of training or learning technique, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, performing backwards propagation of errors can include performing truncated backpropagation through time. The SIM prioritization module 38 can perform a number of generalization techniques (e.g., weight decays, dropouts, etc.) to improve the generalization capability of the model being trained.

In some implementations, the SIM prioritization module 38 can train the machine-learned dynamic profile prioritization model 54 by evaluating training outputs of the model with an optimization function. In some implementations, the SIM prioritization module 38 can utilize an unsupervised training process to train the machine-learned dynamic profile prioritization model 54. For example, the machine-learned dynamic profile prioritization model 54 can be a type of unsupervised model (e.g., a variational autoencoder, etc.) and the optimization function can be an unsupervised learning type optimization function (e.g., K-means clustering, dimensionality reduction, etc.).

Alternatively, in some implementations, the SIM prioritization module 38 can utilize a supervised, semi-supervised, weakly supervised, etc. training process. To do so, the SIM prioritization module 38 can obtain ground truth outputs alongside training prioritization outputs. The ground truth outputs can be “correct” or verified outputs corresponding to the training prioritization outputs. The optimization function can evaluate a difference between the ground truth outputs and the training output. Based on the optimization function, the SIM prioritization module 38 can generate parameter adjustments and apply the parameter adjustments to the machine-learned dynamic profile prioritization model 54. In such fashion, implementations described herein can train the machine-learned dynamic profile prioritization model 54 to dynamically prioritize SIM profiles based on real-time contextual inputs.

In some implementations, the SIM prioritization module 38 can train the machine-learned dynamic profile prioritization model 54 via distillation. More specifically, in some implementations, the SIM prioritization module 38 can train a “full-sized” machine-learned dynamic profile prioritization model 54 (e.g., as a “trainer” model) and distill knowledge from the model to a smaller instance of the model (i.e., a model with fewer parameters) located at the mobile device 40. In this manner, the mobile device 40 can locally prioritize SIM profiles based on the distilled knowledge from the “trainer” machine-learned dynamic profile prioritization model 54 while utilizing substantially fewer computing resources.

The SIM prioritization module 38 can include a profile activation handler 58. The profile activation handler 58 can determine whether a recently generated priority value necessitates activation of an inactive associated SIM profile 24. To follow the depicted example, assume that the set of contextual inputs 46 is processed using the machine-learned dynamic profile prioritization model 54 to generate the priority value 56-N for the associated service 32-1 granted by the associated SIM profile 24-2. The profile activation handler 58 can determine that the associated SIM profile 24-2 is not currently activated by one of the wireless protocol stack instances 18. In response, the profile activation handler 58 can de-activate a SIM profile that is currently activated by one of the wireless protocol stack instances 18 (e.g., the associated SIM profile 24-1 activated by the wireless protocol stack instance 18-2) and then re-assign the wireless protocol stack instance 18 to the associated SIM profile 24-2 and activate the SIM profile with the re-assigned wireless protocol stack instance 18.

It should be noted that an “active” SIM profile refers to a SIM profile that is currently activated with a wireless protocol stack instance, while an “inactive” SIM profile refers to a SIM profile that is not currently activated with a wireless protocol stack instance. Primary SIM profiles and/or associated SIM profiles may either be active or inactive. An “active” service can refer to a service that is granted by a SIM profile that is currently active. In some instances, an active service can refer to a service that is both (a) granted by a currently active SIM profile and (b) is prioritized over a service of the same service type granted by another active SIM profile. For example, if two associated SIM profiles are activated using two wireless protocol stack instances, and the two SIM profiles grant access to two different video streaming services, the video streaming service that with the higher priority can be considered the “active” service. Services, and SIM profiles, can switch between “active” and “inactive” statuses dynamically as services and SIM profiles are prioritized and re-prioritized.

In some implementations, the profile activation handler 58 can issue SIM profile specific instructions. To follow the depicted example, the profile activation handler 58 can generate SIM management instructions 59. The SIM management instructions can instruct the computing device 12 (or the mobile device 40) to perform a specific operation with regards to one or more of the SIM profiles 22/24. Examples of SIM commands include INSERT commands to insert a SIM profile (e.g., if the SIM profile is stored to a physical SIM card (PSIM)), INSTALL commands to install a SIM profile (e.g., if the SIM profile is stored to an electronic SIM card (ESIM), DISABLE commands to disable a SIM profile (e.g., for ESIMs), DELETE commands to delete a SIM profile (e.g., for ESIMs) or REMOVE commands to remove a SIM profile (e.g., for PSIMs). In instances where the instructions or commands require physical interaction with a device, the SIM management instructions 59 can be configured to cause display of user instructions instructing the user to perform the physical interaction (e.g., removing a SIM, inserting a SIM, etc.).

The SIM management instructions 59 can be issued in response to the occurrence of SIM prioritization events, such as the expiration of a hysteresis timer for an associated SIM profile (i.e., a timer that expires when an amount of time has passed since the associated SIM profile was last activated). The below table illustrates example scenarios in which the SIM management instructions 59 are issued. In particular, this table illustrates a number of scenarios that each include a first SIM profile, a second Sim profile, a profile prioritization event, an expected SIM profile activation state (i.e., which SIM Profiles of the set of SIM profiles are expected to be active), and an expected MSO (Multiple System Operator) state.

| | | Other | | | |
|---|---|---|---|---|---|
| | | Installed | Profile | | |
| SIM | SIM | Profiles | Prioritization | | |
| Profile 1 | Profile 2 | (Disabled) | Event | Expected State | MSO State |
| PR PSIM | Empty | — | Hysteresis Timer | PR PSIM + SE | Activated |
| | | | expiry | ESIM | |
| PR ESIM | Empty | — | Hysteresis Timer | PR ESIM + SE | Activated |
| | | | expiry | ESIM | |
| PR PSIM | Empty | NA ESIM | Hysteresis Timer | PR PSIM + SE | Activated |
| | | | expiry | ESIM | |
| PR ESIM | Empty | NA PSIM | Hysteresis Timer | PR ESIM + SE | Activated |
| | | | expiry | ESIM | |
| PR PSIM | SE ESIM | — | Remove PR PSIM | No SIMs available | Deleted |
| PR ESIM | SE ESIM | — | Disable PR ESIM | No SIMs available | Deleted |
| PR ESIM | SE ESIM | — | Delete PR ESIM | No SIMs available | Deleted |

To follow the first example listed in the above table, if the first SIM profile is a primary (PR) physical SIM (PSIM), and the second SIM profile is empty (i.e., there is no other SIM profile activated using a wireless protocol stack instance), then the expected state following the profile prioritization event is to have the PR PSIM activated alongside an associated (SE) electronic SIM (ESIM).

The SIM prioritization module 38 can include a service selector 60. The service selector 60 can select one (or more) services to utilize from multiple active services based on the priority values 56. To follow the depicted example, the primary SIM profile 22 and the associated SIM profile 24-1 can both be activated by the wireless protocol stack instances 18-1 and 18-2, respectively. Both profiles grant access to services 28-1 and 26-1 of the high-speed wireless service type 28-1. Based on the priority values 56 prioritizing the associated service 28-1 over the primary service 26-1, the service selector 60 can select the associated service 56-1 for utilization. If the mobile device 40 allows for usage of multiple high-speed wireless services concurrently, the service selector 60 may select the associated service 56-1 for primary utilization and the primary service 26-1 for secondary utilization (e.g., utilization when additional bandwidth is needed, etc.).

In some implementations, the associated SIM profiles 24 can be prioritized prior to being provided to a mobile device, such as the mobile device 40. For example, assume the SIM profile orchestrator 34 receives information from the mobile device 40 indicating the availability of the wireless protocol stack instance 18-2. The SIM profile orchestrator 34 can determine that the associated SIM profile 24-N is available for provision to the mobile device 40. The SIM profile orchestrator 34 can then prioritize the associated SIM profile 24-N(or services granted by the associated SIM profile 24-N). If the priority of a service granted by the SIM profile 24-N(e.g., associated service 32-1, etc.) is higher than services currently active on the mobile device 40, the SIM profile orchestrator 34 can provide the associated SIM profile 24-N to the mobile device 40 (e.g., provide the SIM profile directly, instruct an associated profile provider 62 to provide the SIM profile, etc.). Conversely, if the priority of a service granted by the SIM profile 24-N(e.g., associated service 32-1, etc.) is lower than the services currently active on the mobile device 40, the SIM profile orchestrator 34 can refrain from providing the associated SIM profile 24-N to the mobile device 40.

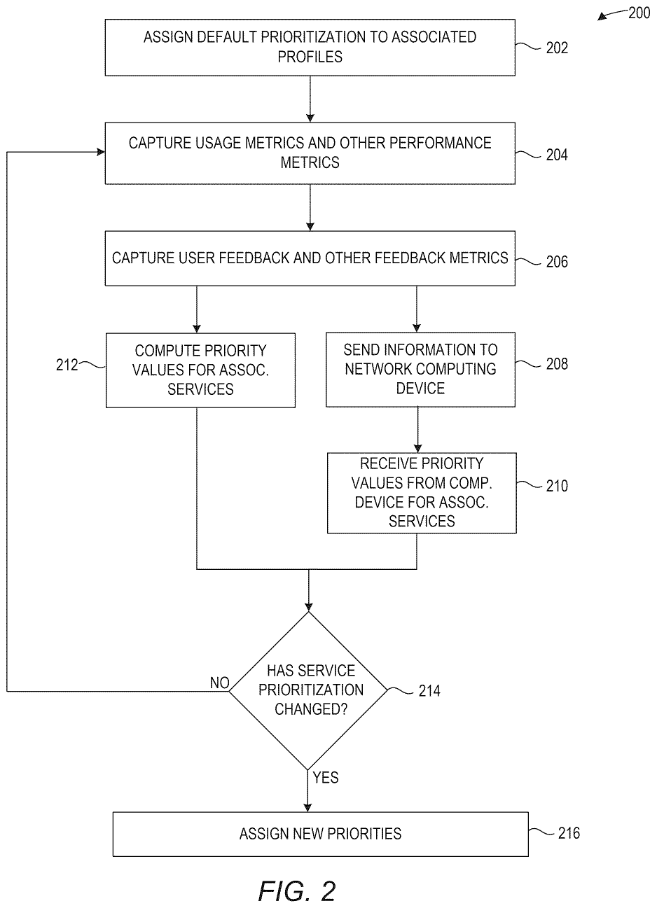

FIG. 2 depicts a flow chart diagram of an example method 200 to perform dynamic prioritization of SIM profiles according to some implementations of the present disclosure. FIG. 2 will be discussed in conjunction with FIG. 1. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, the computing device (e.g., a computing system associated with a network service provider, a mobile device, a UE, etc.) can assign a default prioritization (i.e., default prioritization values) to each of the associated SIM profiles 24. Additionally, or alternatively, in some implementations, the computing device can assign a default prioritization to each of the associated services 28/32 granted by the associated SIM profiles 24.

At 204, the computing device can capture the performance metrics 48 (i.e., usage metrics) for the associated SIM profile, the associated services granted by the associated SIM profile, the mobile device (e.g., the mobile device 40), etc.

At 206, the computing device can capture user feedback and other feedback metrics, such as the state information 50 and the historical information 52.

In some implementations, at 208, the computing device can send the usage metrics and the performance metrics to a network computing device (e.g., the computing device 12, etc.) that can process the information to generate the priority values 56 for the associated SIM profiles 24 (or services granted by the associated SIM profiles 24). At 210, the computing device can receive the priority values 56 from the network computing device.

Alternatively, in some implementations, at 212, the computing device can process the usage metrics and the performance metrics with the machine-learned dynamic profile prioritization model 54 to generate the priority values 56 for the associated SIM profiles 24.

At 214, the computing device can determine whether service prioritization or SIM prioritization has changed. For example, assume the default prioritization values assigned at operation 202 prioritize the first associated service 30-1 over the second associated service 32-1. If the newly computed priority values re-prioritize the second associated service 32-1 such that it is prioritized over the first associated service 30-1, the computing device can determine that service prioritization has changed.

If the service prioritization has changed, at 216, the computing device can assign the newly generated priorities to the associated SIM profiles (or services). If the service prioritization has not changed, the computing device can return to capturing usage metrics and other performance metrics at 204.

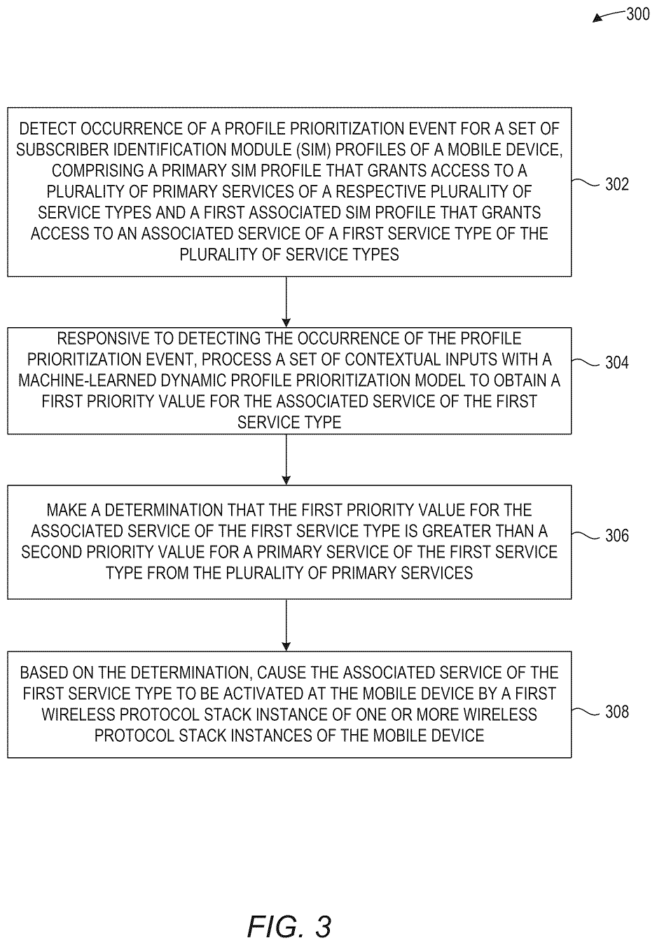

FIG. 3 depicts a flow chart diagram of an example method 300 for local mobile-based prioritization of SIM profiles according to some implementations of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing device (e.g., a network computing device associated with a network service provider, a mobile device, a UE, etc.) can detect occurrence of a profile prioritization event for a set of SIM profiles of a mobile device. The set of SIM profiles can include a primary SIM profile that grants access to a plurality of primary services of a respective plurality of service types. The set of SIM profiles can further include a first associated SIM profile that grants access to an associated service of a first service type of the plurality of service types.

In some implementations, to detect the occurrence of the profile prioritization event, the computing device can determine that a location of the mobile device has changed within a preceding period of time. In some implementations, to do so, the computing device can determine that the location of the mobile device comprises a location within a geographic area associated with the first associated SIM profile. In some implementations, the set of contextual inputs can include the location of the mobile device.

In some implementations, to detect the occurrence of the profile prioritization event, the computing device can receive the first associated SIM profile from a SIM profile provider. The computing device can add the first associated SIM profile to the set of SIM profiles.

In some implementations, to detect the occurrence of the profile prioritization event, the computing device can measure performance metrics for the primary service of the first service type and determine that the performance metrics for the primary service of the first service type are less than threshold performance metrics.

At 304, the computing device can, responsive to detecting the occurrence of the profile prioritization event, process a set of contextual inputs with a machine-learned dynamic profile prioritization model to obtain a first priority value for the associated service of the first service type. In some implementations, the set of contextual inputs can include one or more of a current or previous location of the mobile device, hardware capabilities of the mobile device, device performance metrics associated with a current execution state or a predicted execution state of the mobile device, or network performance metrics associated with the associated service of the first service type. In some implementations, the plurality of service types can include one or more of a high-speed wireless internet service type, a geolocation service type, a wireless communications service type, or a video streaming service type.

At 306, the computing device can make a determination that the first priority value for the associated service of the first service type is greater than a second priority value for a primary service of the first service type from the plurality of primary services.

At 308, the computing device can, based on the determination, cause the associated service of the first service type to be activated at the mobile device by a first wireless protocol stack instance of one or more wireless protocol stack instances of the mobile device.

In some implementations, prior to causing the associated service of the first service type to be activated, the primary service of the first service type is activated by the one or more wireless protocol stack instances of the mobile device. To cause the associated service of the first service type to be activated at the mobile device, the computing device can cause the primary service of the first service type to be deactivated. In some implementations, prior to deactivating the primary service of the first service type, the primary service of the first service type is activated by the first wireless protocol stack instance. The computing device can deactivate the primary service of the first service type by assigning the first wireless protocol stack instance to the associated service of the first service type.

In some implementations, the computing device can obtain updated performance metrics for the associated service of the first service type. The updated performance metrics for the associated service of the first service type can be less than the performance metrics for the primary service of the first service type. Based on the updated performance metrics, the computing device can adjust the first priority value for the associated service of the first service type and/or the second priority value for the primary service of the first service type such that the primary service of the first service type is prioritized over the associated service of the first service type.

In some implementations, the computing device can train the machine-learned dynamic profile prioritization model based on the updated performance metrics for the associated service of the first service type being less than the performance metrics for the primary service of the first service type.

In some implementations, the computing device can add a second associated SIM profile to the set of SIM profiles, wherein the second associated SIM profile grants access to an associated service of a second service type of the plurality of service types. The computing device can process a second set of contextual inputs with a machine-learned dynamic profile prioritization model to obtain a third priority value for the associated service of the second service type. The computing device can make a determination that the third priority value for the associated service of the second service type is greater than a fourth priority value for a primary service of the second service type from the plurality of primary services. Based on the determination, the computing device can cause the associated service of the second service type to be activated at the mobile device by a second wireless protocol stack instance of the plurality of wireless protocol stack instances of the mobile device.

In some implementations, the computing device can cause the associated service of the second service type to be activated at the mobile device by the second wireless protocol stack instance. To do so, the computing device can determine that the second wireless protocol stack instance is available and assign the second wireless protocol stack instance to the associated service of the second service type.

In some implementations, the associated service of the first service type can be one of a set of active services currently activated by the plurality of wireless protocol stack instances. To determine that the second wireless protocol stack instance is available, the computing device can determine that a quantity of active services within the set of active services is less than a quantity of wireless protocol stack instances within the plurality of wireless protocol stack instances.

In some implementations, to cause the associated service of the first service type to be activated at the mobile device, the computing device can instruct the mobile device to activate the associated service of the first service type by the first wireless protocol stack instance. Alternatively, in some implementations, the computing device can be or otherwise include the mobile device can activate the associated service locally.

In some implementations, to cause the associated service of the first service type to be activated at the mobile device, the computing system can determine that a hysteresis timer associated with the associated service of the first service type has expired. The hysteresis timer can be previously initiated when the associated service of the first service type was last prioritized.

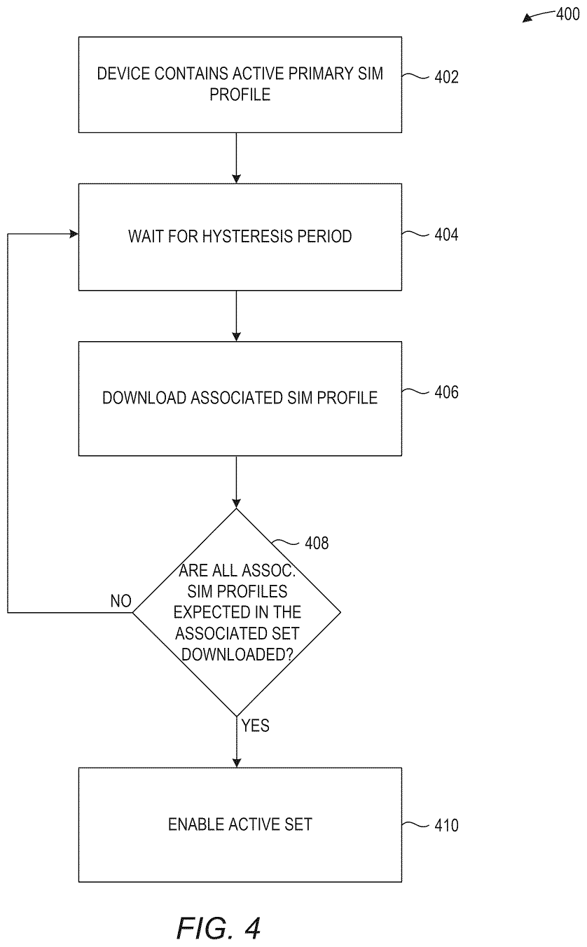

FIG. 4 depicts a flow chart diagram of an example method 400 for downloading associated SIM profiles for local mobile-based prioritization of SIM profiles according to some implementations of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing device (e.g., a network computing device associated with a network service provider, a mobile device, a UE, etc.) can determine whether the device includes an active primary SIM primary SIM profile.

At 404, the computing device can wait for a hysteresis period. As described above, a hysteresis period or hysteresis timer can refer to a timer that expires when an amount of time has passed since the associated SIM profile was last activated (or any associated SIM profile was last activated).

At 406, the computing device can download the associated SIM profile after waiting for the hysteresis period at 404. The associated SIM profile can grant access to one or more associated services.

At 408, the computing device can determine if all associated SIM profiles expected in a set of associated SIM profiles have been downloaded. If all of the associated SIM profiles have not been downloaded, the computing device can return to 404 to wait for the hysteresis period (or another hysteresis period) to expire. For example, at 406, the computing device may initiate another hysteresis timer after downloading the associated SIM profile.

At 410, if all of the associated SIM profiles have been downloaded, the computing device can enable an active set of SIM profiles. The active set of SIM profiles can refer to SIM profiles that are activated using wireless protocol stack instances. As such, to enable the active set, the computing device can first activate one of the associated SIM profiles that has been downloaded with an available wireless protocol stack instance. If another wireless protocol stack instance is available, the computing device can activate another associated SIM profile from the associated set of SIM profiles.

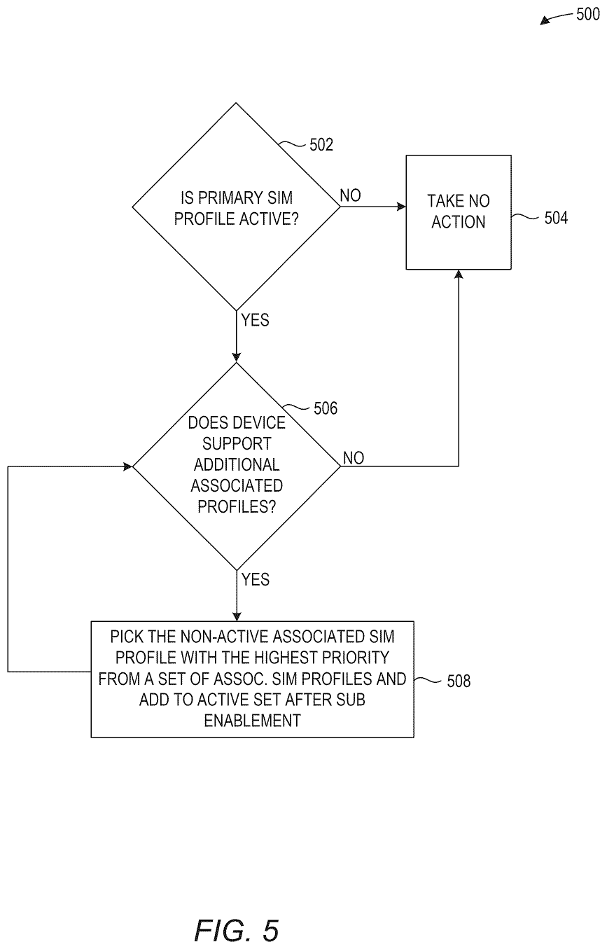

FIG. 5 depicts a flow chart diagram of an example method 500 for enabling an active set of SIM profiles for local mobile-based prioritization of SIM profiles according to some implementations of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing device (e.g., a network computing device associated with a network service provider, a mobile device, a UE, etc.) can determine whether a primary SIM profile is currently activated by a wireless protocol stack instance.

At 504, if a primary SIM profile is not currently activated, the computing device can take no further action.

At 506, if the primary SIM profile is currently active, the computing device can determine if the device supports additional associated SIM profiles. For example, assume that the computing device includes a single wireless protocol stack instance. In this scenario, because the wireless protocol stack instance must be used to activate the primary SIM profile, the computing device does not include another wireless protocol stack instance to activate an associated SIM profile, and therefore, the device does not support additional associated profiles. Similarly, if the device included two wireless protocol stack instances, and the two stack instances were currently being used to activate the primary SIM profile and an associated SIM profile, the device would not support additional associated profiles. In such scenarios, the computing device can return to operation 504 and take no further action.

At 508, if the device does support additional associated profiles, the computing device can pick the non-active associated SIM profile with the highest priority from a set of non-active associated SIM profiles and activate the non-active associated SIM profile (e.g., with the available wireless protocol stack instance) after profile enablement.

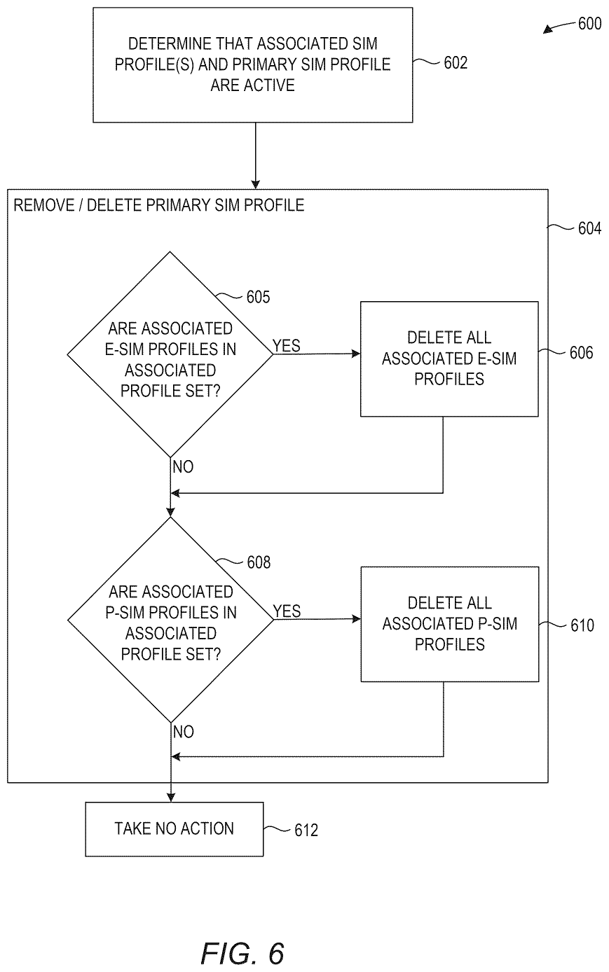

FIG. 6 depicts a flow chart diagram of an example method 600 for deleting and/or removing a primary SIM profile for local mobile-based prioritization of SIM profiles according to some implementations of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing device (e.g., a network computing device associated with a network service provider, a mobile device, a UE, etc.) can determine that one or more associated SIM profiles and the primary SIM profile of the device are currently active (i.e., activated using wireless protocol stack instances of the device). The associated SIM profiles associated to the primary SIM profile are also referred to as a set of associated SIM profiles. When a primary SIM profile is disabled or removed, each of the SIM profiles associated with the primary SIM profile can also be disabled and/or removed.

At 604, the computing device can remove or delete the primary SIM profile. To do so, at 605, the computing device can determine whether associated SIM profiles in the associated set are “E-SIM” profiles. As described previously, an “E-SIM” profile can refer to a SIM profile that is implemented or stored to the device using electronic or digital SIM technologies.

At 606, if the computing device identifies associated SIM profiles in the associated set as E-SIM profiles, the computing device can delete all associated E-SIM profiles.

At 608, the computing device can determine whether associated SIM profiles in the associated set are “P-SIM” profiles. As described previously, a “P-SIM” profile can refer to a SIM profile that is implemented or stored to the device using physical SIM technologies, such as a SIM card inserted physically into the device.

At 610, if the computing device identifies associated SIM profiles in the associated set as P-SIM profiles, the computing device can disable all associated P-SIM profiles.

At 612, if no E-SIM profiles and P-SIM profiles remain in the associated profile set, the computing device can take no further action.

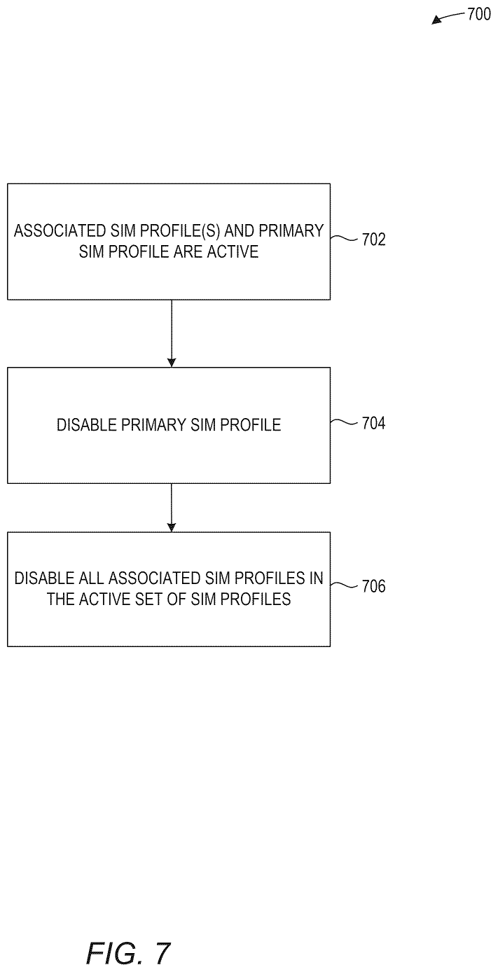

FIG. 7 depicts a flow chart diagram of an example method 700 for disabling a primary SIM profile for local mobile-based prioritization of SIM profiles according to some implementations of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing device (e.g., a network computing device associated with a network service provider, a mobile device, a UE, etc.) can determine whether a primary SIM profile and associated SIM profile(s) are active. The computing device can determine to disable the primary SIM profile, and as such, must necessarily disable all associated SIM profiles that are currently active.

In response, at 704, the computing device can disable the primary SIM profile.

At 706, the computing device can disable all associated SIM profiles in the active set of SIM profiles.

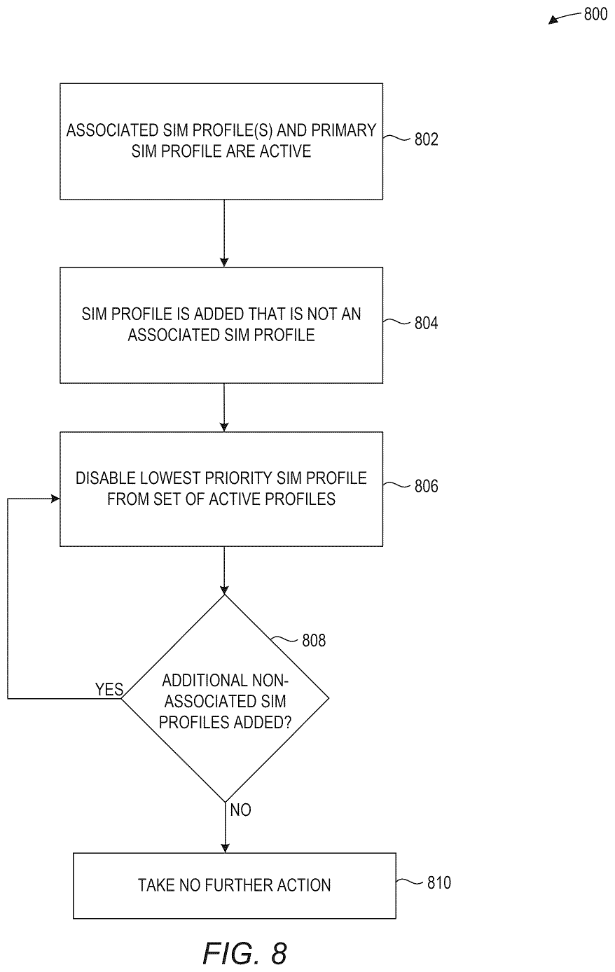

FIG. 8 depicts a flow chart diagram of an example method 800 for adding a non-associated SIM profile for local mobile-based prioritization of SIM profiles according to some implementations of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing device (e.g., a network computing device associated with a network service provider, a mobile device, a UE, etc.) can determine whether a primary SIM profile and associated SIM profile(s) are active.

At 804, the computing device can determine that a SIM profile has been added to the device that is not an associated SIM profile (i.e., a non-associated SIM profile). A non-associated SIM profile can refer to a SIM profile that is not associated with the primary SIM profile. For example, the recently added SIM profile may be another primary SIM profile.

At 806, the computing device can disable the lowest priority SIM profile from the set of active SIM profiles. In some implementations, the computing device can prioritize the SIM profiles of the set of active SIM profiles directly (e.g., calculating a priority value for the SIM profile itself). Alternatively, in some implementations, the computing device can prioritize the SIM profiles based on an aggregate or average priority of the services to which a SIM profile grants access. For example, if a SIM profile grants access to a single service, the priority of the SIM profile can be determined based on the priority of the service relative to other active services of the same service type.

At 808, the computing device can determine if there are additional non-associated Sim profiles added to the device. If so, the computing device can disable the next lowest priority SIM profile from the set of active SIM profiles.

At 810, if the computing device determines there are no more additional non-associated SIM profiles added to the device, the computing device can take no further action.

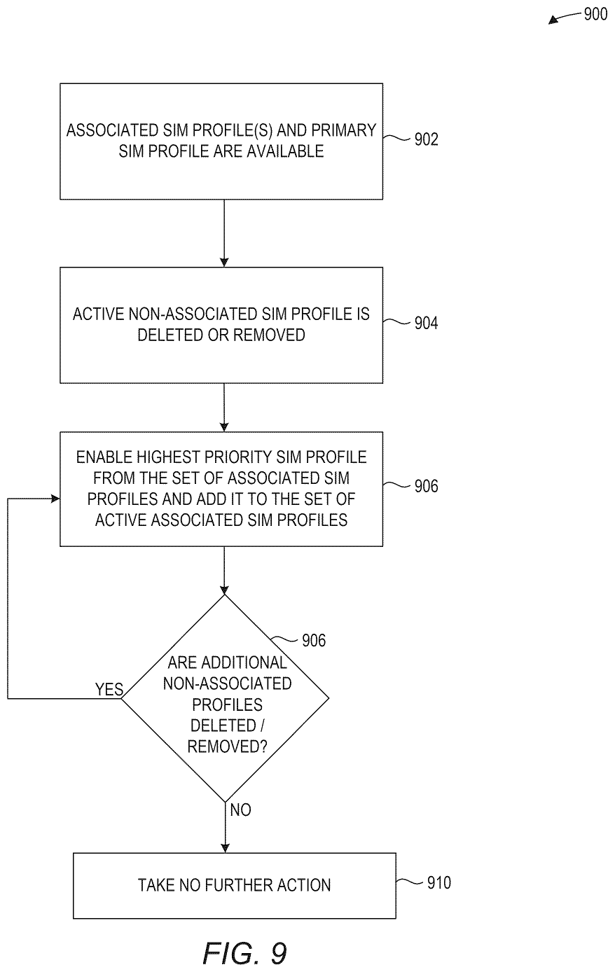

FIG. 9 depicts a flow chart diagram of an example method 900 for disabling/removing a non-associated SIM profile for local mobile-based prioritization of SIM profiles according to some implementations of the present disclosure. Although FIG. 9 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, a computing device (e.g., a network computing device associated with a network service provider, a mobile device, a UE, etc.) can determine associated SIM profiles are available in the device alongside the primary SIM profile.

At 904, the computing device can determine that a non-associated SIM profile has been disabled or removed from the device.

At 906, the computing device can enable the highest priority SIM profile from the set of active SIM profiles.

At 908, the computing device can determine if there are additional non-associated Sim profiles of the device have been removed or disabled. If so, the computing device can enable the next highest priority SIM profile from the set of active SIM profiles.

At 910, if the computing device determines there are no more additional non-associated SIM profiles added to the device, the computing device can take no further action.

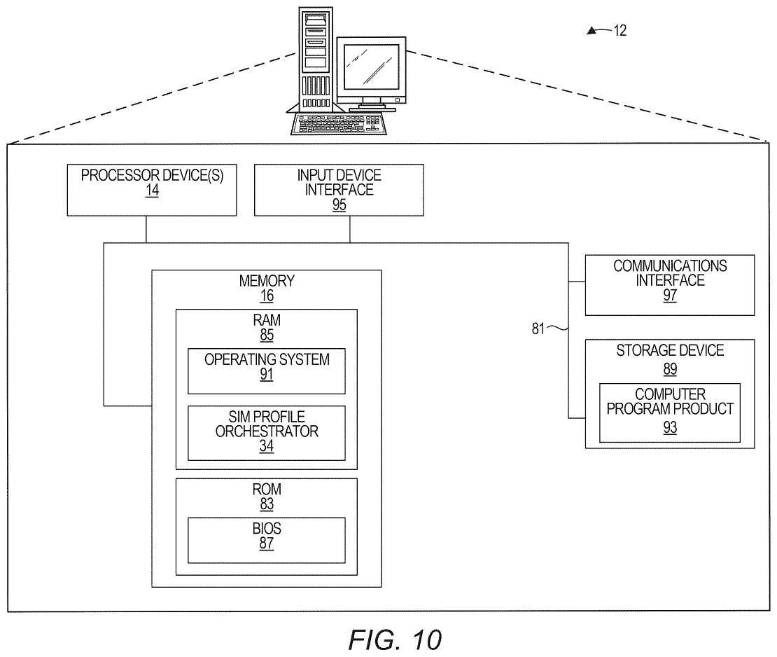

FIG. 10 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 12 includes the processor device(s) 14, the memory 16, and a system bus 81. The system bus 81 provides an interface for system components including, but not limited to, the memory 16 and the processor device(s) 14. The processor device(s) 14 can be any commercially available or proprietary processor.

The system bus 81 may be any of several types of bus structures that may further interconnect to a memory bus (with or without a memory controller), a peripheral bus, and/or a local bus using any of a variety of commercially available bus architectures. The memory 16 may include non-volatile memory 83 (e.g., read-only memory (ROM), erasable programmable read-only memory (EPROM), electrically erasable programmable read-only memory (EEPROM), etc.), and volatile memory 85 (e.g., random-access memory (RAM)). A basic input/output system (BIOS) 87 may be stored in the non-volatile memory 83 and can include the basic routines that help to transfer information between elements within the computing device 12. The volatile memory 85 may also include a high-speed RAM, such as static RAM, for caching data.

The computing device 12 may further include or be coupled to a non-transitory computer-readable storage medium such as the storage device 89, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 89 and other drives associated with computer-readable media and computer-usable media may provide non-volatile storage of data, data structures, computer-executable instructions, and the like.

A number of modules can be stored in the storage device 89 and in the volatile memory 85, including an operating system 91 and one or more program modules, such as the SIM profile orchestrator 34, which may implement the functionality described herein in whole or in part. All or a portion of the examples may be implemented as a computer program product 93 stored on a transitory or non-transitory computer-usable or computer-readable storage medium, such as the storage device 89, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the SIM profile orchestrator 34 in the volatile memory 85, may serve as a controller, or control system, for the computing device 12 that is to implement the functionality described herein.

Because the SIM profile orchestrator 34 is a component of the computing device 12, functionality implemented by the SIM profile orchestrator 34 may be attributed to the computing device 12 generally. Moreover, in examples where the SIM profile orchestrator 34 comprises software instructions that program the processor device(s) 14 to carry out functionality discussed herein, functionality implemented by the SIM profile orchestrator 34 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 95 that is coupled to the system bus 81 but can be connected by other interfaces such as a parallel port, an Institute of Electrical and Electronic Engineers (IEEE) 1394 serial port, a Universal Serial Bus (USB) port, an IR interface, and the like. The computing device 12 may also include the communications interface 97 suitable for communicating with the network as appropriate or desired. The computing device 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising,
detecting, by a computing device comprising one or more processor devices, an occurrence of a profile prioritization event for a set of Subscriber Identification Module (SIM) profiles of a mobile device, the set of SIM profiles comprising:
a primary SIM profile that grants access to a plurality of primary services of a respective plurality of service types; and
a first associated SIM profile that grants access to an associated service of a first service type of the plurality of service types;
responsive to detecting the occurrence of the profile prioritization event, processing, by the computing device, a first set of contextual inputs with a machine-learned dynamic profile prioritization model to obtain a first priority value for the associated service of the first service type;
making, by the computing device, a determination that the first priority value for the associated service of the first service type is greater than a second priority value for a primary service of the first service type from the plurality of primary services; and
based on the determination, causing, by the computing device, the associated service of the first service type to be activated at the mobile device by a first wireless protocol stack instance of one or more wireless protocol stack instances of the mobile device.

2. The method of claim 1, wherein detecting the occurrence of the profile prioritization event comprises:
determining, by the computing device, that a location of the mobile device has changed within a preceding period of time.

3. The method of claim 2, wherein determining that the location of the mobile device has changed comprises:
determining, by the computing device, that the location of the mobile device comprises a location within a geographic area associated with the first associated SIM profile.

4. The method of claim 2, wherein the first set of contextual inputs comprises the location of the mobile device.

5. The method of claim 1, wherein detecting the occurrence of the profile prioritization event comprises:
receiving, by the computing device, the first associated SIM profile from a SIM profile provider; and
adding, by the computing device, the first associated SIM profile to the set of SIM profiles.

6. The method of claim 1, wherein the first set of contextual inputs comprises one or more of:
a current or previous location of the mobile device;
hardware capabilities of the mobile device;
device performance metrics associated with a current execution state or a predicted execution state of the mobile device; or
network performance metrics associated with the associated service of the first service type.

7. The method of claim 1, wherein the plurality of service types comprises one or more of:
a high-speed wireless internet service type;
a geolocation service type;
a wireless communications service type; or
a video streaming service type.

8. The method of claim 1, wherein, prior to causing the associated service of the first service type to be activated, the primary service of the first service type is activated by the one or more wireless protocol stack instances of the mobile device, and wherein causing the associated service of the first service type to be activated at the mobile device further comprises:
causing, by the computing device, the primary service of the first service type to be deactivated.

9. The method of claim 8, wherein, prior to causing the primary service of the first service type to be deactivated, the primary service of the first service type is activated by the first wireless protocol stack instance, and wherein causing the primary service of the first service type to be deactivated further comprises:
assigning, by the computing device, the first wireless protocol stack instance to the associated service of the first service type.

10. The method of claim 1, wherein detecting the occurrence of the profile prioritization event comprises:
measuring, by the computing device, performance metrics for the primary service of the first service type; and
determining, by the computing device, that the performance metrics for the primary service of the first service type are less than threshold performance metrics.

11. The method of claim 10, wherein the method further comprises:
obtaining, by the computing device, updated performance metrics for the associated service of the first service type, wherein the updated performance metrics for the associated service of the first service type are less than the performance metrics for the primary service of the first service type; and
based on the updated performance metrics, adjusting, by the computing device, the first priority value for the associated service of the first service type and/or the second priority value for the primary service of the first service type such that the primary service of the first service type is prioritized over the associated service of the first service type.

12. The method of claim 11, further comprising:
training, by the computing device, the machine-learned dynamic profile prioritization model based on the updated performance metrics for the associated service of the first service type being less than the performance metrics for the primary service of the first service type.

13. The method of claim 1, wherein the one or more wireless protocol stack instances comprise a plurality of wireless protocol stack instances, and wherein the method further comprises:
adding, by the computing device, a second associated SIM profile to the set of SIM profiles, wherein the second associated SIM profile grants access to an associated service of a second service type of the plurality of service types;
processing, by the computing device, a second set of contextual inputs with the machine-learned dynamic profile prioritization model to obtain a third priority value for the associated service of the second service type;
making, by the computing device, a determination that the third priority value for the associated service of the second service type is greater than a fourth priority value for a primary service of the second service type from the plurality of primary services; and
based on the determination that the third priority value is higher, causing, by the computing device, the associated service of the second service type to be activated at the mobile device by a second wireless protocol stack instance of the plurality of wireless protocol stack instances of the mobile device.

14. The method of claim 13, wherein causing the associated service of the second service type to be activated at the mobile device by the second wireless protocol stack instance comprises:
determining, by the computing device, that the second wireless protocol stack instance is available; and
assigning, by the computing device, the second wireless protocol stack instance to the associated service of the second service type.

15. The method of claim 14, wherein the associated service of the first service type is one of a set of active services to which access is granted by a subset of SIM profiles of the set of SIM profiles, the subset of SIM profiles being currently activated by the plurality of wireless protocol stack instances, and wherein determining that the second wireless protocol stack instance is available comprises:
determining, by the computing device, that a quantity of SIM profiles within the subset of SIM profiles currently activated by the plurality of wireless protocol stack instances is less than a quantity of wireless protocol stack instances within the plurality of wireless protocol stack instances.

16. The method of claim 1, wherein causing the associated service of the first service type to be activated at the mobile device comprises:
instructing, by the computing device, the mobile device to activate the associated service of the first service type with the first wireless protocol stack instance.

17. The method of claim 1, wherein the computing device comprises the mobile device, and wherein causing the associated service of the first service type to be activated at the mobile device comprises:
activating the associated service of the first service type the first wireless protocol stack instance of the one or more wireless protocol stack instances.

18. The method of claim 1, wherein causing the associated service of the first service type to be activated at the mobile device comprises:
determining, by the computing device, that a hysteresis timer associated with the associated service of the first service type has expired, wherein the hysteresis timer was previously initiated when the associated service of the first service type was last prioritized.

19. A mobile device, comprising:
a memory; and
a processor device coupled to the memory to:
detect an occurrence of a profile prioritization event for a set of Subscriber Identification Module (SIM) profiles of the mobile device, the set of SIM profiles comprising:
a primary SIM profile that grants access to a plurality of primary services of a respective plurality of service types; and
a first associated SIM profile that grants access to an associated service of a first service type of the plurality of service types;
responsive to detecting the occurrence of the profile prioritization event, process a first set of contextual inputs with a machine-learned dynamic profile prioritization model to obtain a first priority value for the associated service of the first service type;
make a determination that the first priority value for the associated service of the first service type is greater than a second priority value for a primary service of the first service type from the plurality of primary services; and
based on the determination, activate the associated service of the first service type with a first wireless protocol stack instance of one or more wireless protocol stack instances of the mobile device.

20. A non-transitory computer-readable storage medium that includes executable instructions to cause one or more processor devices to:
detect an occurrence of a profile prioritization event for a set of Subscriber Identification Module (SIM) profiles of a mobile device, the set of SIM profiles comprising:
a primary SIM profile that grants access to a plurality of primary services of a respective plurality of service types; and
a first associated SIM profile that grants access to an associated service of a first service type of the plurality of service types;
responsive to detecting the occurrence of the profile prioritization event, process a first set of contextual inputs with a machine-learned dynamic profile prioritization model to obtain a first priority value for the associated service of the first service type;
make a determination that the first priority value for the associated service of the first service type is greater than a second priority value for a primary service of the first service type from the plurality of primary services; and
based on the determination, cause the associated service of the first service type to be activated at the mobile device by a first wireless protocol stack instance of one or more wireless protocol stack instances of the mobile device.

21. The non-transitory computer-readable storage medium of claim 20, wherein, to cause the associated service of the first service type to be activated at the mobile device by the first wireless protocol stack instance, the one or more processor devices are to:
transmit instructions to the mobile device to activate the associated service of the first service type with the first wireless protocol stack instance of the one or more wireless protocol stack instances of the mobile device.

22. The non-transitory computer-readable storage medium of claim 20, wherein, to process the first set of contextual inputs with the machine-learned dynamic profile prioritization model, the one or more processor devices are to:
receive at least one contextual input of the first set of contextual inputs from the mobile device.
